(19) United States
(12) Patent Application Publication
(10) Pub. No.: US 2017/0282349 A1
(43) Pub. Date: Oct. 5, 2017

(54) ASSEMBLED TOOL CABINET

(71) Applicant: GStandard Products Inc., San Jose, CA (US)

(72) Inventor: Xiongwen Zhao, Jiangshu (CN)

(73) Assignee: GStandard Products Inc.

(21) Appl. No.: 15/197,332

(22) Filed: Jun. 29, 2016

(30) Foreign Application Priority Data
Mar. 29, 2016 (CN) 201610186173.6

(51) Int. Cl. B25H 3/00; A47B 96/02; A47B 57/40; A47B 81/00; A47B 47/00

(52) U.S. Cl. CPC B25H 3/00; A47B 81/00; A47B 47/0075; A47B 57/406; A47B 96/024

(57) ABSTRACT

A tool cabinet comprises a front frame; a rear frame; a door panel; a back panel; a side panel; a shelf; a top panel; a bottom panel; and a supporting leg. The tool cabinet is combined with the front frame and the rear frame thereof serving as the main body, such that the structure of combined tool cabinet is stable, the manufacturing process thereof is improved, the components thereof are properly spaced, and the tool cabinet can be disassembled easily. As the tool cabinet is combined from various components, the packaging thereof is reduced by two third, significantly reducing the transportation cost and resources consumed.

### CROSS-REFERENCE TO RELATED APPLICATION(S)

This application claims priority to the Chinese Patent Application Ser. No. 201610186173.6, filed Mar. 29, 2016 and titled, “Assembled Tool Cabinet,” which is also hereby incorporated by reference in its entirety for all purposes.

### FIELD OF THE INVENTION

The present invention relates to a tool cabinet.

### BACKGROUND OF THE INVENTION

A typical double door tool cabinet generally has a unitary structure and cannot be assembled conveniently. In the typical double door tool cabinet, the assembly and disassembly of the double door tool cabinet rely on the configuration of insertion boards and the corresponding slots. The aforementioned double door tool cabinet is structurally unstable and may deform easily.

### SUMMARY OF THE INVENTION

In an aspect, a combined tool cabinet is provided, which is combined with the front frame and the rear frame thereof serving as the main body so that the combined tool cabinet is structurally stable and the disassembly and transportation thereof is convenient.

In some embodiments, the tool cabinet comprises a front frame; a rear frame; a door panel; a back panel; a side panel; a top panel; a bottom panel; a shelf; and a supporting leg; wherein the front frame and the rear frame are rectangular in shape and define screw holes on respective rear jambs thereof for connecting with the side panel; and wherein the respective rear jambs of the front frame and the rear frame are bent inwardly at their edges.

In some embodiments, the thresholds of the front frame and the rear frame define screw holes at their bottom surfaces for connecting with the supporting leg.

A flange defining a hole for mounting the door panel is provided at the front surface of each of a header and the threshold of the front frame. When the door panel is mounted, a screw nut is riveted to each of the upper and lower flanges of the door panel, and then a screw bolt is threaded into the screw nut on the door panel and passes through the hole on the flange of the front frame. The screw bolt herein is able to be a customized screw bolt comprising a head section, a threaded section and a smooth section, wherein the threaded section matches the threads of the screw nut on the door panel and the smooth section passes through the hole on the flange of the front frame.

For the front frame and rear frame, the front surfaces of the header and the threshold thereof define a plurality of vias for connecting to the wall.

In some embodiments, the edges of the top panel are provided with a plurality of T-shaped insertion pieces; the top edges of the front frame, the rear frame and the side panel define slots mating with the plurality of T-shaped insertion pieces.

In some embodiments, the inwardly bent portions of the rear jambs of the front frame and the rear frame are provided with a plurality of clamping members for securing the shelf. Each clamping member consists of two metal pieces capable of being pulled outwardly. The inwardly bent portions of the rear jambs of the front frame and the rear frame define a plurality of lateral slots each of which is located at the center of the two metal pieces of the clamping member for receiving a hook-shaped engaging member configured to sustain the shelf. When the shelf is to be secured, a rear end of the hook-shaped engaging member is inserted to the lateral slot. Next, the shelf is placed upon the hook-shaped engaging member, and then the upper metal piece is pulled outwardly to secure the shelf in position.

In some embodiments, there are multiple shelves; an edge of each of the multiple shelves is downwardly bent.

In some embodiments, each of the side panel and the back panel is provided with a reinforcing rib at the central area thereof. The reinforcing rib comprises an engaging end configured to securely engage the shelf and a securing end configured to be secured to the side panel and the back panel. The joint of the engaging end and the securing end of the reinforcing rib has a bending angle of less than 90°. When the shelf is to be secured, an edge thereof is inserted to the engaging end of the reinforcing rib.

In some embodiments, the tool cabinet is combined with the front frame and the rear frame serving as the main body so that the combined tool cabinet is structurally stable, and the disassembly and transportation thereof is convenient. Moreover in some embodiments, two configurations are provided whereby the shelves are secured. In some embodiments, for a smaller tool cabinet, a lateral slot is defined at the center of the two metal pieces of the clamping member for receiving a hook-shaped engaging member configured to sustain the shelf from its bottom. Meanwhile, the upper metal piece of the clamping member is pulled open to secure the shelf from its top. In some embodiments, for a larger upright tool cabinet, each of the back panel and the side panel is provided with a reinforcing rib, and an edge of the shelf can be inserted to the reinforcing rib. In some embodiments, the use of the reinforcing rib is able to be advantageous in that: the shelf is stably secured to the reinforcing rib, and that securing the shelf to the reinforcing rib can reinforce the back panel and the side panel of a larger upright tool cabinet which may not be stably secured. In some embodiments, the manufacturing process is simplified due to the omission of numerous complicated welding steps, yet the tool cabinet of the present invention is more stable than the prior art tool cabinet combined by using bolts. Moreover, the tapered design enables the components of the tool cabinet to be securely connected, thereby preventing the swinging problem commonly associated with the use of bolts and hinge-connected doors and the falling off of the components.

### BRIEF DESCRIPTION OF THE DRAWINGS

FIG. 1 is an exploded view of a combined tool cabinet in accordance with some embodiments.

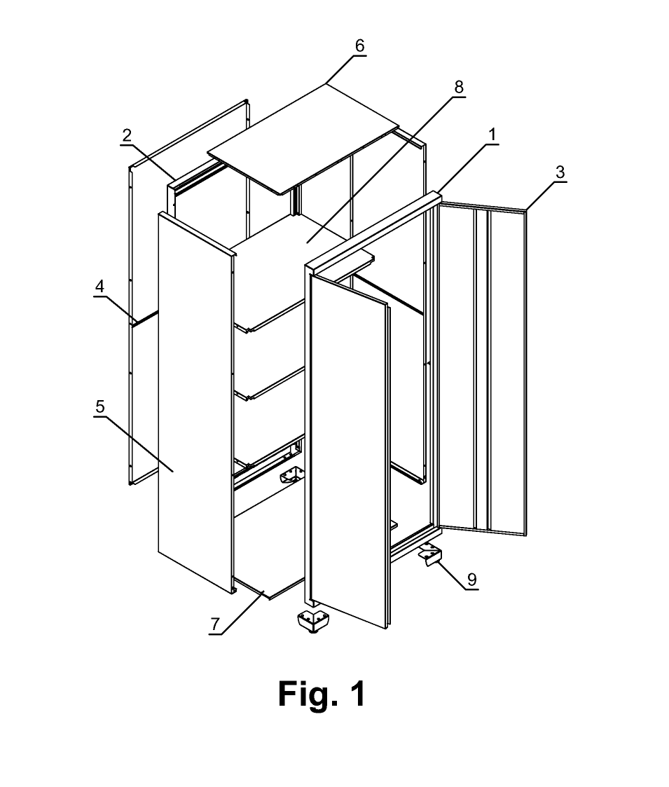

FIG. 2 is a perspective view of a front frame in accordance with some embodiments.

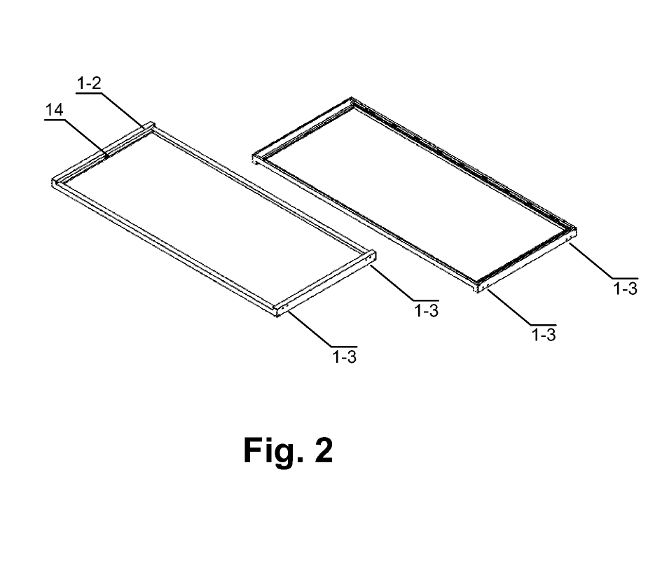

FIG. 3 is a perspective view of a rear frame in accordance with some embodiments.

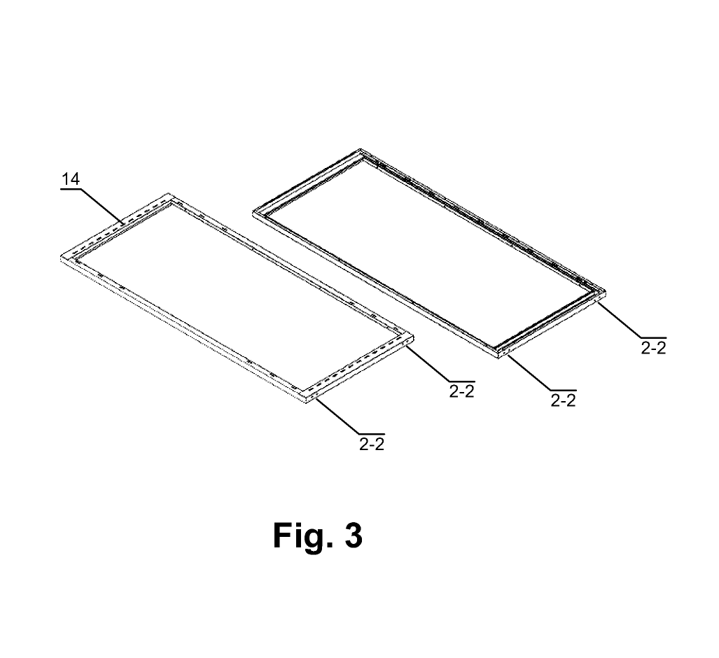

FIG. 4 is a schematic view showing the connection of the rear frame and a side panel (the connection of the front frame and the side panel is performed in the same manner) in accordance with some embodiments.

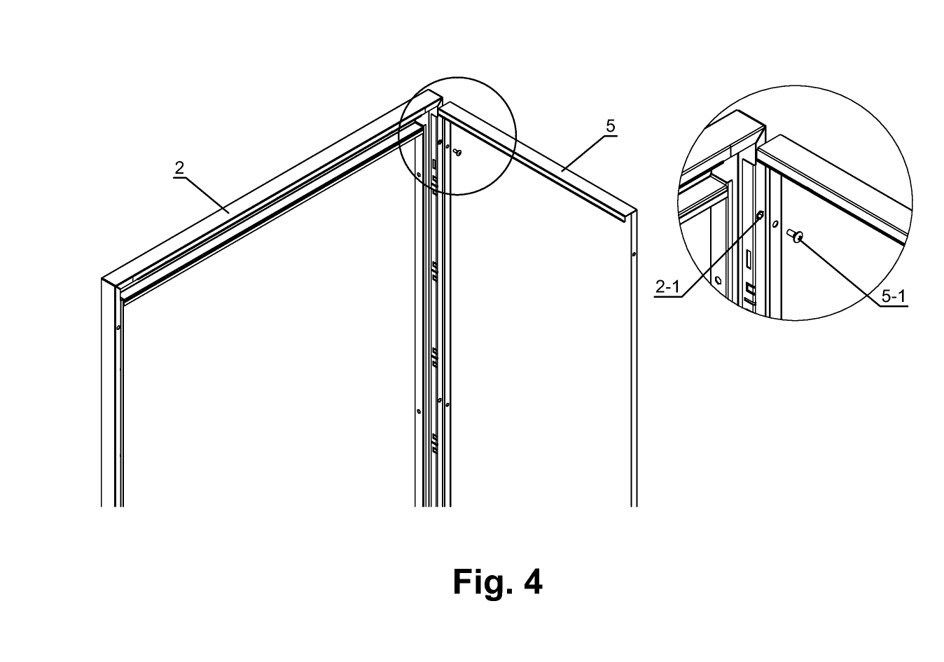

FIG. 5 is a schematic view of a door panel in accordance with some embodiments.

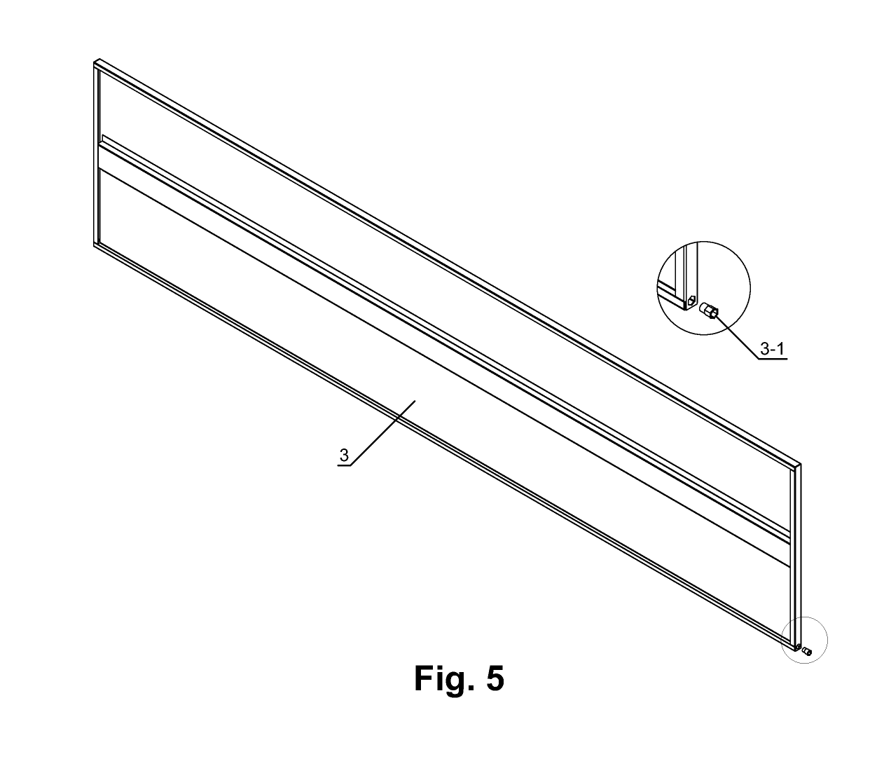

FIG. 6 is a schematic view showing the mounting of the door panel in accordance with some embodiments.

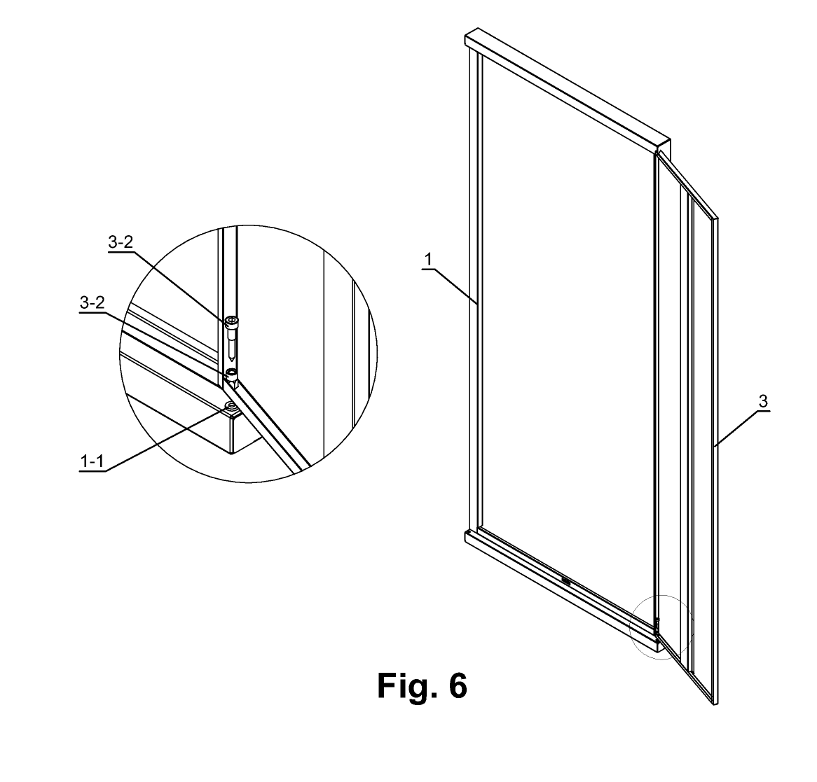

FIG. 7 is a schematic view showing a screw bolt of the door panel in accordance with some embodiments.

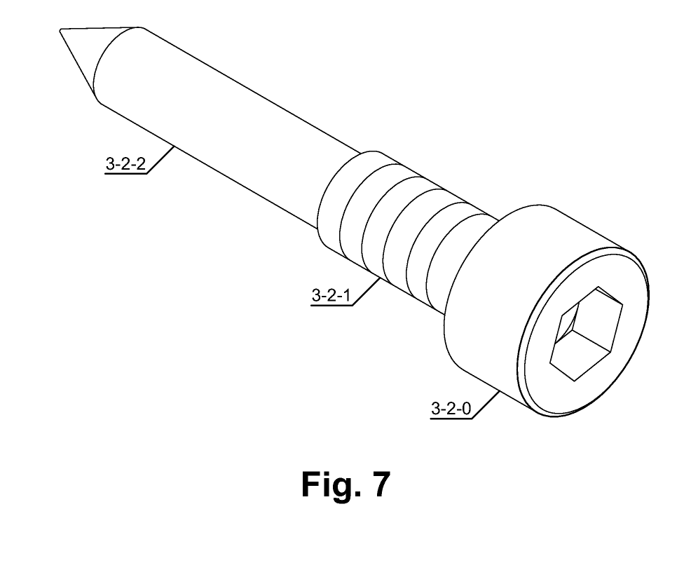

FIG. 8 is a schematic view showing the connection of the rear frame, the side panel and a top panel (the connection of the front frame, the side panel and the top panel is performed in the same manner) in accordance with some embodiments.

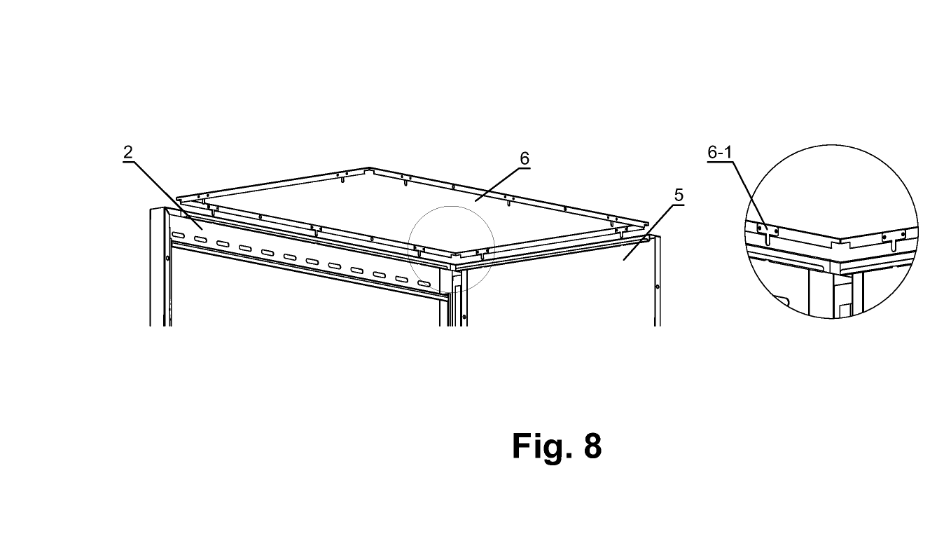

FIG. 9 is a schematic view of a clamping member in accordance with some embodiments.

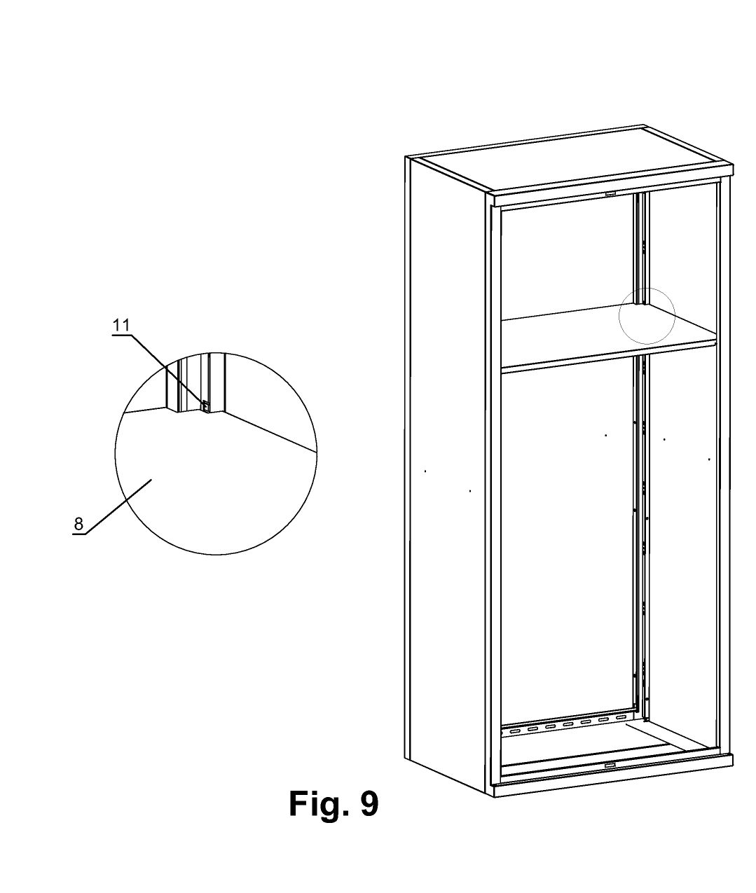

FIG. 10 is a schematic view showing the clamping member and a hook-shaped engaging member in accordance with some embodiments.

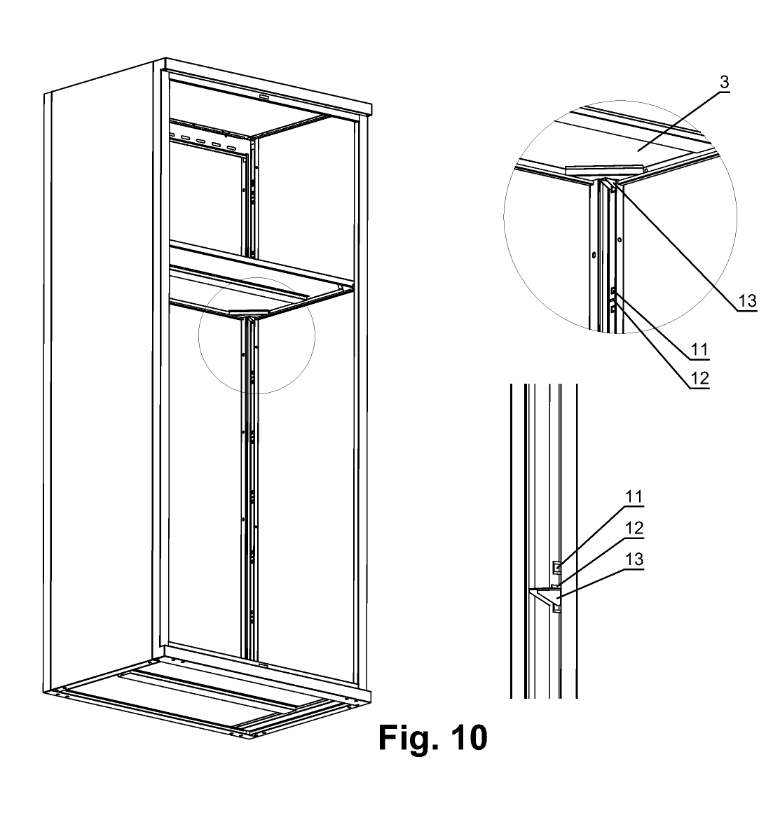

FIG. 11 is a schematic view of a reinforcing rib in accordance with some embodiments.

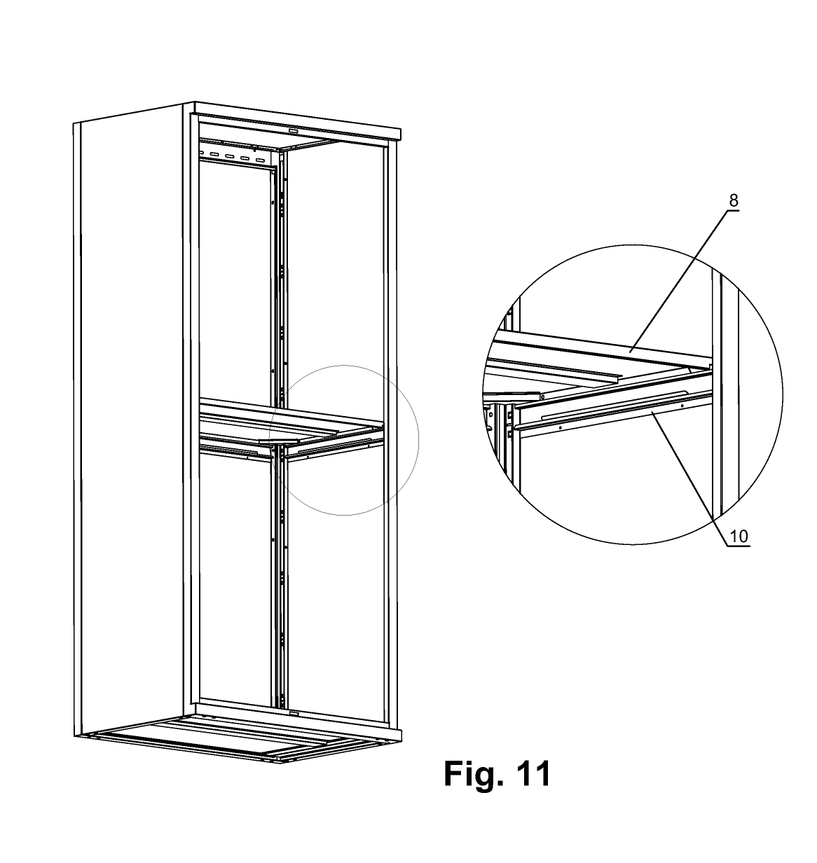

FIG. 12 is a cross-section view of the reinforcing rib in accordance with some embodiments.

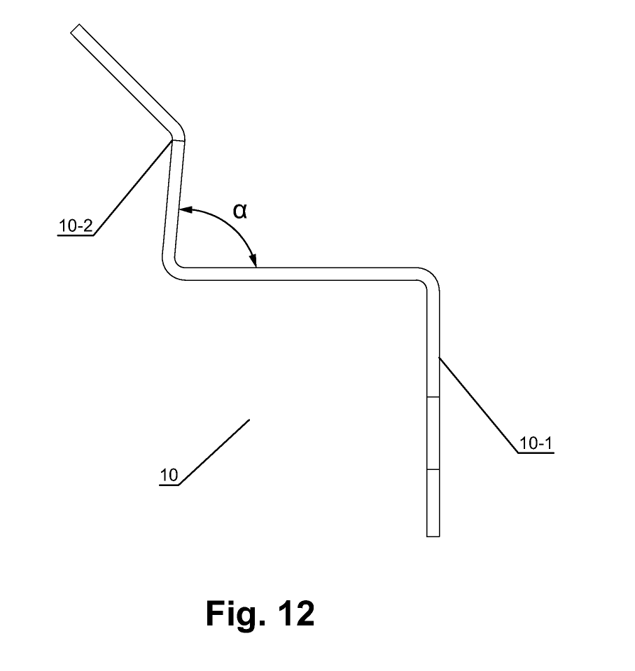

### DETAILED DESCRIPTION OF THE PREFERRED EMBODIMENT

The following contain exemplary embodiments by reference to the appended drawings. The embodiments are provided to elucidate the technical solution of the present invention and are not intended to limit the scope of protection of the present invention.

Where possible, any terms expressed in the singular form herein are meant to also include the plural form and vice versa, unless explicitly stated otherwise. Also, as used herein, the term “a” and/or “an” shall mean “one or more”, even though the phrase “one or more” is also used herein.

### Embodiment 1

In some embodiments, an assembled/assemblable tool cabinet comprises: a front frame 1; a rear frame 2; a door panel 3; a back panel 4; a side panel 5; a top panel 6; a bottom panel 7; a shelf 8; and a supporting leg 9; wherein the front frame 1 and the rear frame 2 are rectangular in shape and define screw holes on respective rear jambs thereof for connecting with the side panel 5; and wherein the respective rear jambs of the front frame 1 and the rear frame 2 are bent inwardly at their edges.

The thresholds of the front frame 1 and the rear frame 2 define screw holes at their bottom surfaces for connecting with the supporting leg 9.

A flange 1-2 defining a hole 1-1 for mounting the door panel 3 is provided at the front surface of each of a header and the threshold of the front frame 1. When the door panel 3 is mounted, a screw nut 3-1 is riveted to each of the upper and lower flanges of the door panel 3, and then a screw bolt 3-2 is threaded into the screw nut 3-1 on the door panel 3 and passes through the hole 1-1 on the flange 1-2 of the front frame 1. The screw bolt 3-2 herein is a customized screw bolt comprising a head section 3-2-0, a threaded section 3-2-1 and a smooth section 3-2-2, wherein the threaded section 3-2-1 matches the threads of the screw nut 3-1 on the door panel 3 and the smooth section 3-2-2 passes through the hole 1-1 on the flange 1-2 of the front frame 1.

For the rear frame 2, the front surfaces of the header and the threshold thereof define a plurality of vias 14 for connecting to the wall.

The edges of the top panel 6 are provided with a plurality of T-shaped insertion pieces 6-1; the top edges of the front frame 1, the rear frame 2 and the side panel 5 define slots mating with the plurality of T-shaped insertion pieces 6-1.

The inwardly bent portions of the rear jambs of the front frame 1 and the rear frame 2 are provided with a plurality of clamping members 11 for securing the shelf 8. Each clamping member 11 consists of two metal pieces capable of being pulled outwardly. The inwardly bent portions of the rear jambs of the front frame 1 and the rear frame 2 define a plurality of lateral slots 12 each of which is located at the center of the two metal pieces of the clamping member 11. When the shelf 8 is to be secured, a rear end of a hook-shaped engaging member 13 is inserted to the lateral slot 12. Next, the shelf 8 is placed upon the hook-shaped engaging member 13, and then the upper metal piece is pulled outwardly to secure the shelf 8 in position.

### Embodiment 2

There is provided a combined tool cabinet comprising: a front frame 1; a rear frame 2; a door panel 3; a back panel 4; a side panel 5; a top panel 6; a bottom panel 7; a shelf 8; and a supporting leg 9; wherein the front frame 1 and the rear frame 2 are rectangular in shape and define screw holes on respective rear jambs thereof for connecting with the side panel 5; and wherein the respective rear jambs of the front frame 1 and the rear frame 2 are bent inwardly at their edges.

The thresholds of the front frame 1 and the rear frame 2 define screw holes at their bottom surfaces for connecting with the supporting leg 9.

A flange 1-2 defining a hole 1-1 for mounting the door panel 3 is provided at the front surface of each of a header and the threshold of the front frame 1. When the door panel 3 is to be mounted, a screw nut 3-1 is riveted to each of the upper and lower flanges of the door panel 3, and then a screw bolt 3-2 is threaded into the screw nut 3-1 on the door panel 3 and passes through the hole 1-1 on the flange 1-2 of the front frame 1. The screw bolt 3-2 herein is a customized screw bolt comprising a head section 3-2-0, a threaded section 3-2-1 and a smooth section 3-2-2, wherein the threaded section 3-2-1 matches the threads of the screw nut 3-1 on the door panel 3 and the smooth section 3-2-2 passes through the hole 1-1 on the flange 1-2 of the front frame 1.

For the rear frame 2, the front surfaces of the header and the threshold thereof define a plurality of vias 14 for connecting to the wall.

The edges of the top panel 6 are provided with a plurality of T-shaped insertion pieces 6-1; the top edges of the front frame 1, the rear frame 2 and the side panel 5 define slots mating with the plurality of T-shaped insertion pieces 6-1.

There are multiple shelves 8; an edge of each of the multiple shelves 8 is downwardly bent.

Each of the side panel 5 and the back panel 4 is provided with a reinforcing rib 10 at the central area thereof. The reinforcing rib 10 comprises an engaging end 10-2 configured to securely engage the shelf 8 and a securing end 10-1 configured to be secured to the side panel 5 and the back panel 4. The joint of the engaging end 10-2 and the securing end 10-1 of the reinforcing rib 10 has a bending angle a of less than 90°. When the shelf 8 is to be secured, an edge thereof is inserted to the engaging end 10-2 of the reinforcing rib 10.

In some embodiments, the front frame and back frame used herein includes front door frame and rear door frame respectively.

In utilization, the tool cabinet is able to be used for tools storage.

In operation, the front and back frames are used as a main/frame structure of the tool cabinets. Panels and shelves are installed on the structure.

Although exemplary embodiments of the present invention have been described above, it is to be noted that those skilled in the art can make a number of changes and modifications without departing from the spirit of the present invention, and that such changes and modifications shall be within the scope of protection of the present invention.

1. A tool cabinet comprising:
a) a front frame having a first rigid structure; and
b) a back frame having a second rigid structure, wherein the first rigid structure and the second rigid structure form a backbone structure of the tool cabinet, wherein the front frame is rectangular in shape and defines screw holes on a rear jamb thereof for connecting with a side panel; and wherein a portion of the front frame is bent inwardly at their edges to be the rear jamb with the screw holes.

2. The cabinet of claim 1, wherein the front frame, the back frame, or both comprise a shape in rectangular.

3. The cabinet of claim 1, further comprises one or more door panels pivotally coupled with the front frame.

4. The cabinet of claim 1, further comprises a back panel covering an opening of the back frame.

5. The cabinet of claim 1, wherein the side panel, a top panel, a bottom panel, or a shelf is between the front frame and the back frame.

6. The cabinet of claim 1, wherein the front frame, back frame, or both comprise one or more screw holes for immobilizing with the side panel.

7. The cabinet of claim 1, wherein the front frame, the back frame, or both comprise jambs bent inwardly.

8. The cabinet of claim 1, wherein the front frame, back frame, or both comprise one or more screw holes for connecting with one or more supporting legs.

9. A tool cabinet comprises
a) a front frame;
b) a rear frame;
c) a door panel;
d) a back panel;
e) a side panel;
f) a top panel;
g) a bottom panel;
h) a shelf; and
i) a supporting leg; wherein the front frame and the rear frame are rectangular in shape and define screw holes on respective rear jambs thereof for connecting with the side panel; and wherein the respective rear jambs of the front frame and the rear frame are bent inwardly at their edges.

10. The tool cabinet of claim 9, wherein the front frame and the rear frame comprise thresholds that define screw holes at their bottom surfaces for connecting with the supporting leg.

11. The tool cabinet of claim 10, further comprises a flange defining a hole for mounting the door panel, which is provided at a front surface of each of a header and the threshold of the front frame, and that when the door panel is to be mounted, a screw nut is riveted to each of upper and lower flanges of the door panel, and a screw bolt is threaded into the screw nut on the door panel and passes through the hole on the flange of the front frame.

12. The tool cabinet of claim 11, wherein the screw bolt comprises a head section, a threaded section and a smooth section, and that the threaded section matches threads of the screw nut on the door panel and the smooth section passes through the hole on the flange of the front frame.

13. The tool cabinet of claim 9, wherein the rear frame, front surfaces of a header and a threshold thereof define a plurality of vias for connecting to the wall.

14. The tool cabinet of claim 9, further comprises edges of a top panel, which are provided with a plurality of T-shaped insertion pieces, and top edges of the front frame, the rear frame and a side panel define slots mating with the plurality of T-shaped insertion pieces.

15. The tool cabinet of claim 9, further comprises inwardly bent portions of rear jambs of the front frame and the rear frame, which are provided with a plurality of clamping members for securing the shelf, and that each clamping member comprises two metal pieces capable of being pulled outwardly.

16. The tool cabinet of claim 9, further comprises inwardly bent portions of rear jambs of the front frame and the rear frame, which define a plurality of lateral slots for receiving hook-shaped engaging members configured to sustain the shelf.

17. The tool cabinet of claim 9, wherein the side panel and the back panel are provided with a reinforcing rib at a central area thereof, and the reinforcing rib comprises an engaging end configured to securely engage the shelf and a securing end configured to be secured to the side panel and the back panel, and wherein a joint of an engaging end and a securing end of the reinforcing rib has a bending angle less than 90°.

18. The tool cabinet of claim 9, further comprise multiple shelves, wherein an edge of each of the multiple shelves is downwardly bent.
